(19) United States
(12) Patent Application Publication
(10) Pub. No.: US 2009/0069082 A1
(43) Pub. Date: Mar. 12, 2009

(54) GAMING MACHINE

(75) Inventor: James William Morrow, Sparks, NV (US)

Correspondence Address: MCANDREWS HELD & MALLOY, LTD, 500 WEST MADISON STREET, SUITE 3400, CHICAGO, IL, 60661, US

(73) Assignee: Aristocrat Technologies Australia Pty Ltd, Lane Cove NSW (AU)

(21) Appl. No.: 12/099,568

(22) Filed: Apr. 8, 2008

(30) Foreign Application Priority Data
Apr. 17, 2007 (AU) 2007902018

(51) Int. Cl. A63F 13/00

(52) U.S. Cl. 463/31

(57) ABSTRACT

Certain embodiments provide an electronic gaming component including an audio visual (A/V) device having an A/V output; an A/V input arranged to obtain a signal indicative of an A/V output of at least one peer electronic gaming component; and a controller in communication with the A/V input and arranged to control the A/V output of the A/V device based on the obtained signal. Certain embodiments provide a method of controlling an audio visual (A/V) device of an electronic gaming component including obtaining a signal indicative of the A/V output of at least one peer gaming machine; and controlling the output of the A/V device of the electronic gaming component based on the obtained signal.

### CROSS-REFERENCE TO RELATED APPLICATIONS

This application claims priority to Australian Provisional Patent Application No. 2007902018, having an international filing date of Apr. 17, 2007, entitled “A Gaming Machine,” which is hereby incorporated by reference herein in its entirety.

### FIELD

This application relates to an electronic gaming machine, a gaming system comprising a plurality of electronic gaming machines, a controller for an electronic gaming machine, a gaming network, and a method of controlling an interactive component such as an audio visual device of an electronic gaming machine.

### BACKGROUND OF THE INVENTION

It is known to control the display of a gaming machine or lights associated with the gaming machine based on the game play outcome.

It has also been proposed for a central controller in a gaming network to control the audio output of a gaming machine based on the outcome of a game on another gaming machine.

There is a need for alternative techniques for interaction between gaming machines.

### SUMMARY OF THE INVENTION

In a first aspect, the invention provides an electronic gaming component comprising:
an audio visual (A/V) device comprising an A/V output;
an A/V input arranged to obtain a signal indicative of an A/V output of at least one peer electronic gaming component; and
a controller in communication with the A/V input and arranged to control the A/V output of the A/V device based on the obtained signal.

In an embodiment, the A/V input comprises a sensor arranged to measure the A/V output of the peer electronic gaming component and to output the signal indicative of the A/V output of the at lease one peer gaming component.

In an embodiment, the A/V device comprises at least one of an audio output device or a visual output device.

In an embodiment, the A/V input is arranged to receive an A/V output communicated from the peer electronic gaming component via a data link.

In an embodiment, the A/V device comprises a visual output device and the A/V input is arranged to obtain a signal indicative of the visual output of the peer gaming component.

In an embodiment, the electronic gaming component is an electronic gaming machine (EGM)

In an embodiment, the A/V device comprises a display of the EGM.

In an embodiment, the A/V device comprises a light tower of the EGM.

In an embodiment, the A/V device comprises a lighting bezel of the EGM.

In an embodiment, the A/V device operates independently of other A/V devices of the electronic gaming component.

In an embodiment, the controller is further arranged to control the output of the A/V device based on a game outcome of the EGM.

In an embodiment, the controller is further arranged to control the A/V device based on a current A/V output.

In an embodiment, the A/V input is arranged to output a signal indicative of an A/V output of at least one peer EGM.

In an embodiment, the A/V input is arranged to obtain at least one signal indicative of the A/V outputs of a plurality of peer gaming components.

In an embodiment, the electronic gaming component is configured to control at least one aspect of game play based on the A/V input.

In a second aspect, the invention provides a gaming system comprising a plurality of electronic gaming components, each electronic gaming component comprising:
an audio visual (A/V) device comprising an A/V output;
an A/V input arranged to obtain a signal indicative of an A/V output of at least one other electronic gaming component of the plurality of electronic gaming components; and
a controller in communication with the A/V input and arranged to control the A/V output of the A/V device based on the obtained signal.

In an embodiment, at least one electronic gaming component is an electronic gaming machine.

In an embodiment, at least one electronic gaming component is a display of a bonus or jackpot system.

In an embodiment, the plurality of electronic gaming components are connected in a peer-to-peer data network for communicating a signal indicative of an A/V output of at least one other electronic gaming component to the respective A/V inputs.

In an embodiment, each electronic gaming component is arranged to obtain a signal indicative of the A/V output of each electronic gaming component of a peer group of electronic gaming components to which the EGM belongs.

In an embodiment, the gaming system comprises a plurality of peer groups of electronic gaming components, and wherein the A/V input is arranged to obtain a signal indicative of an A/V output of another peer group, and the controller is arranged to control the output of the A/V device.

In an embodiment, each of the electronic gaming components is an electronic gaming machine.

In an embodiment, each the A/V input comprises a sensor arranged to measure the A/V output of the at least one electronic gaming component and to output the signal indicative of the A/VV output.

In an embodiment, each A/V device comprises a visual output device and the A/V input is arranged to obtain a signal indicative of the visual output of the at least one other gaming component.

In an embodiment, the electronic gaming component is an electronic gaming machine (EGM) and the A/V device comprises a display of the EGM.

In an embodiment, the electronic gaming component is an electronic gaming machine (EGM) and the A/V device comprises a light tower of the EGM.

In an embodiment, the electronic gaming component is an electronic gaming machine (EGM) and the A/V device comprises a lighting bezel of the EGM.

In an embodiment, each A/V device operates independently of any other A/V devices of the electronic gaming component.

In an embodiment, each controller is further arranged to control the output of the A/V device based on a game outcome of the EGM.

In an embodiment, each controller is further arranged to control the A/V device based on a current A/V output.

In an embodiment, each electronic gaming component is an electronic gaming machine configured to control at least one aspect of game play based on the A/V input.

In a third aspect, the invention provides a controller for an electronic gaming component, the controller arranged to control an A/V output of A/V device of the electronic gaming component based on a signal obtained by an A/V input of the electronic gaming component, the signal being indicative of an A/V output of at least one peer electronic gaming component.

In a fourth aspect there is provided a gaming network comprising:
a plurality of peer groups of electronic gaming components, each electronic gaming component comprising an A/V output device, each peer group of electronic gaming components configured such that individual electronic gaming components control their respective A/V output devices based on the A/V output of at least one peer within the group and based on any received A/V modification data; and
a central controller in data communication with each of the groups and arranged to provide A/V modification data to at least one group of the plurality of groups of electronic gaming components based on the output of A/V output devices of at least one other group of electronic gaming components.

In an embodiment, the electronic gaming components are electronic gaming machines.

In a fifth aspect, the invention provides method of controlling an audio visual (A/V) device of an electronic gaming component comprising:
obtaining a signal indicative of the A/V output of at least one peer gaming machine; and
controlling the output of the A/V device of the electronic gaming component based on the obtained signal.

In a sixth aspect, the invention provides an electronic gaming component comprising:
at least one interactive component;
an interactivity input arranged to receive interactivity data from at least one peer electronic gaming component; and
a controller arranged to control the interactive component based on the interactivity data.

In an embodiment, the electronic gaming component is an electronic gaming machine.

In an embodiment, the interactive component is selected from the group comprising an audio visual device, a game outcome generator, and a reel controller.

In an embodiment, the electronic gaming component further comprises an interactivity data output arranged to output interactivity data to at least one other peer EGM.

In a seventh aspect, the invention provides an electronic gaming system comprising a plurality of electronic gaming components connected in a peer-to-peer data network, each electronic gaming component comprising:
at least one interactive component;
an interactivity input arranged to receive interactivity data from at least one peer electronic gaming component; and
a controller arranged to control the interactive component based on the interactivity data.

In an embodiment, the interactivity input is arranged to receive interactivity data from all peers in the peer-to-peer network.

In an eighth aspect, the invention provides a controller for an electronic gaming component, the controller arranged to control an interactive component of the electronic gaming component based on interactivity data received from at least one peer electronic gaming component.

In a ninth aspect, the invention provides a gaming network comprising:
a plurality of peer groups of electronic gaming components, each electronic gaming component comprising at least one interactive component, each peer group of electronic gaming components configured such that individual electronic gaming components control their interactive components based on interactivity data received from at least one peer within the group and based on any received interactivity modification data; and
a central controller in data communication with each of the groups and arranged to provide interactivity modification data to at least one group of the plurality of groups of electronic gaming components based on the interactivity data of at least one other group of electronic gaming components.

In a tenth aspect, the invention provides an method of controlling an interactive component of an electronic gaming electronic gaming component comprising:
receiving interactivity data from at least one peer gaming machine; and
controlling the interactive component of the electronic gaming component based on the received signal.

### BRIEF DESCRIPTION OF THE DRAWINGS

Certain embodiments of the invention will now be described in relation to the following drawings in which:

FIG. 1 is a block diagram of an electronic gaming machine;

FIG. 2 is a perspective drawing of a gaming machine according to an embodiment;

FIG. 3 is a block diagram of the electronic gaming machine of FIG. 2;

FIG. 4 is a block diagram of gaming machines of an alternative embodiment;

FIG. 5a is a block diagram of a gaming room;

FIG. 5b is a block diagram of the gaming network defined by the gaming room of FIG. 5a; and

FIGS. 6a and 6b are flow charts of embodiments of the invention.

### DETAILED DESCRIPTION

Some embodiments of the present invention relate generally to an electronic gaming components such as electronic gaming machines (EGMs) having an audio visual device with an audio visual output whose output is controlled at least partially based on an audio visual output of at least one peer electronic gaming machine. In other embodiments electronic gaming components such as electronic gaming machines comprise at least one interactive component and the interactive component is controlled by interactivity data received from at least one peer EGM.

Herein, an “electronic gaming component” is most typically an electronic gaming machine but can be another gaming component, for example, a jackpot system or a bonus system and in particular, the displays of such systems.

“Peer” electronic gaming components are, as will be apparent from the following description either those explicitly connected to form a peer group or those components which have the capacity to directly affect one another, for example in embodiments which employ sensors to obtain peer information, peers may be those components within range of the sensors. In some embodiments, an electronic gaming component may belong to more than one peer group. In some embodiments, gaming components which are peers of one another may have different sets of peers.

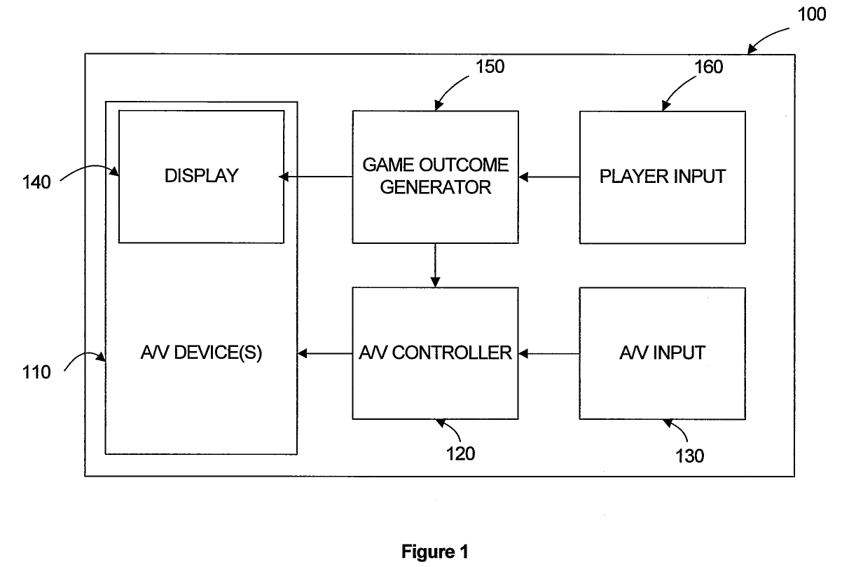

The core components of an electronic gaming machine having an audio visual device with an audio visual output whose output is controlled at least partially based on an audio visual output of at least one peer electronic gaming machine are illustrated in FIG. 1. An electronic gaming machine 100 comprises at least one audio visual device 110 that is under the control of an audio visual controller 120. The audio visual controller 120 controls the audio visual device 110 based on a signal obtained by an audio visual input 130 that is indicative of an audio visual output of at least one peer electronic gaming machine.

Depending on the specific embodiment, the audio visual device may output an audio signal, a visual signal or a combination of audio and visual. It will be also appreciated that there may be a plurality of audio visual devices 110. It will also be appreciated that some or all of these audio visual devices may be under the sole control of the audio visual controller 110. The most notable example of an audio visual device that may or may not be under the control of an audio visual controller 120 is the display 140. As illustrated in FIG. 1, the display 140 will at least be under the control of the game outcome generator 150 which controls the display of game outcomes that it generates in response to player input 160 so that a player can see the result of a game on the display 140. In some embodiments, the audio visual controller 120 may modify the display 140, for example by altering the background colours of the display 140 based on the audio visual input 130. Alternatively, a separate audio visual device 110 may be provided and only this device may be controlled by the audio visual controller 120.

The audio visual controller 120 may base its control partly on an outcome generated by the game outcome generator 150. In this mode of operation the output of the audio visual device(s) is advantageously based not only on the outcomes of games played on electronic gaming machine 100 but those of peer electronic gaming machines which are reflected in their own audio visual outputs.

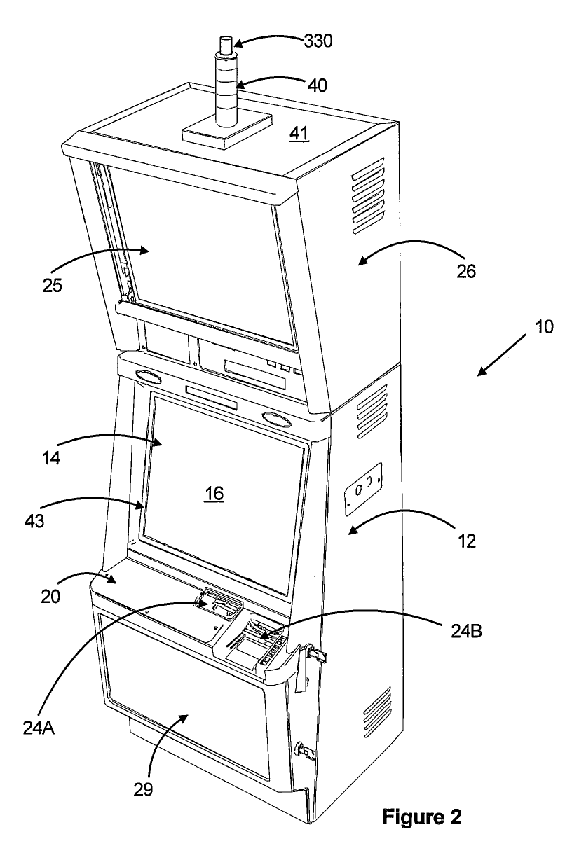

Referring to FIG. 2 there is shown an electronic gaming machine. The gaming machine 10 includes a console 12 having a display 14 on which is displayed representations of a game 16 that can be played by a player. Display 14 is surrounded by a bezel 43 having lighting embedded therein. A mid-trim 20 of the gaming machine 10 houses a bank of buttons for enabling a player to interact with the gaming machine, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. A reading device may also be provided for the purpose of reading a player tracking device, for example as part of a loyalty program. The player tracking device may be in the form of a card, flash drive or any other portable storage medium capable of being read by the reading device, for example an RFID device.

The top box 26 has a display for example a video display unit, which may be of the same type as the display 14, or of a different type. The displays 14 and 25 shown in FIG. 2 are in the form of a video display unit, particularly a cathode ray tube screen device. Alternatively, the display 14 may be a liquid crystal display, plasma screen, any other suitable video display unit, or the visible portion of an electromechanical device.

The gaming machine 10 has a light tower 40 capable of emitting light in a number of different colours to indicate the operating state of the machine for example if the machine has a fault.

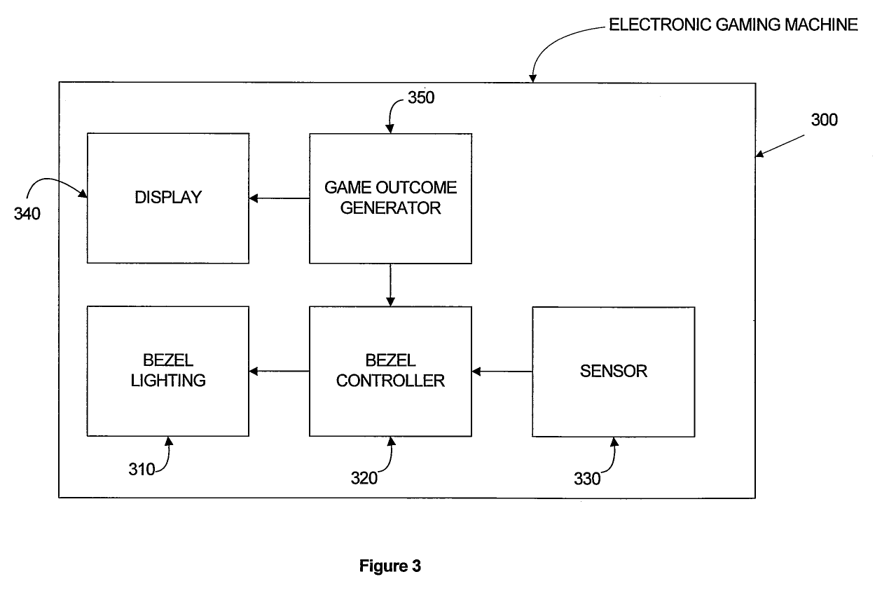

FIG. 3 illustrates the electronic gaming machine of FIG. 2 as a block diagram. The electronic gaming machine 300 comprises bezel lighting 310 which is controlled by bezel controller 320. Game outcomes are displayed independently on display 340 under control of the game outcome generator 350. The bezel controller 320 receives input signals from the sensor 330 which measures light output from surrounding gaming machines. The bezel controller 320 also receives an input from the game outcome generator 350. The bezel controller 320 employs a control algorithm to determine bezel lighting parameters based on the signals received from the sensor 330 and the outcome generator 350 and controls the bezel lighting 310 accordingly.

Persons skilled in the art will appreciate that an advantage of employing a sensor is that the sensor 330 can reflect the prevailing lighting conditions from neighbouring gaming machines and other gaming components so that a lighting effect can be achieved where light spreads from gaming machine to gaming machine. A sensor 330 can also measure ambient light so it can be taken into account. In a particularly embodiment, the light output from the bezel has certain characteristics to enable the gaming machine to sense and distinguish the light from other lighting: for example it pulses at a particular frequency or it is emitted within a particular frequency band. As shown in FIG. 2 the sensor 330 can be mounted on the top of a light tower 40.

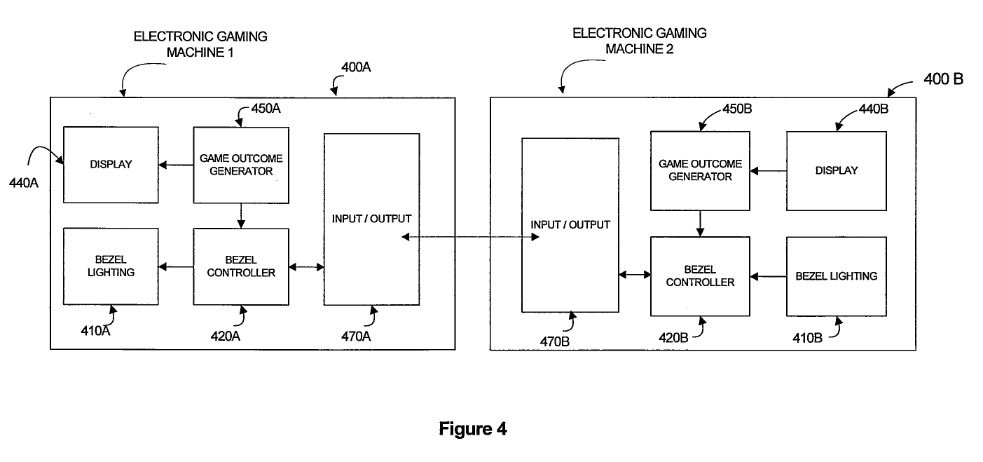

Persons skilled in the art will appreciate that in some environments it may not be practical to sense the light of another gaming machine and accordingly it may be appropriate to link the plurality of electronic gaming machines in a peer-to-peer data network to enable them to communicate data reflecting their lighting status. A number of different types of data links may be used to link gaming machines, for example an infrared link, a blue tooth link, a wireless link, or a fixed cable such as Ethernet. An embodiment with a data link is illustrated schematically in FIG. 4 in relation to two gaming machines although a person skilled in the art will appreciate that this technique can readily be extended to any number of gaming machines. Communication via the data link may occur using any suitable communication scheme including infrared communication, radio frequency communication and other data communication techniques such as TCP/IP.

The electronic gaming machines 400A and 400B of FIG. 4 are constructed generally in the same manner as the electronic gaming machine of FIG. 3 except for the sensor 330 is replaced by input/output devices 470 in each of the electronic gamine machines 400. That is, each electronic gaming machine has a display 440, a game outcome generator 450, bezel lighting 410 and a bezel controller 420. In this exemplary embodiment the bezel controllers are configured to output their current lighting status via input/output devices 470 over data link 480. Thus, the electronic gaming machines exchange current lighting data. Each bezel controller 420 then controls its own bezel lighting 410 based on data received from its own game outcome generator 450 and the other bezel controller 420.

A person skilled in the art will appreciate that the above technique can be used to generate organic lighting effects where lighting generated from a winning outcome on one gaming machine can spread to another gaming machine. A variety of control algorithms can be employed in order to control the spread of the lighting effects. For example, to control the effect of the lighting so that it has a reduced effect the further a gaming machine is from another gaming machine which has a winning outcome. In general, the goal of a control algorithm is to alter the audio visual output of peer gaming machines to show that they have become “excited” based on outcomes on other gaming machines. Thus, there would typically be a period of excitement and then a gradual reduction in rates and changes.

Persons skilled in the art will appreciate that gaming machines may interact with other peer gaming components in a gaming room for example a display displaying a progressive jackpot amount or displaying awarding of a jackpot.

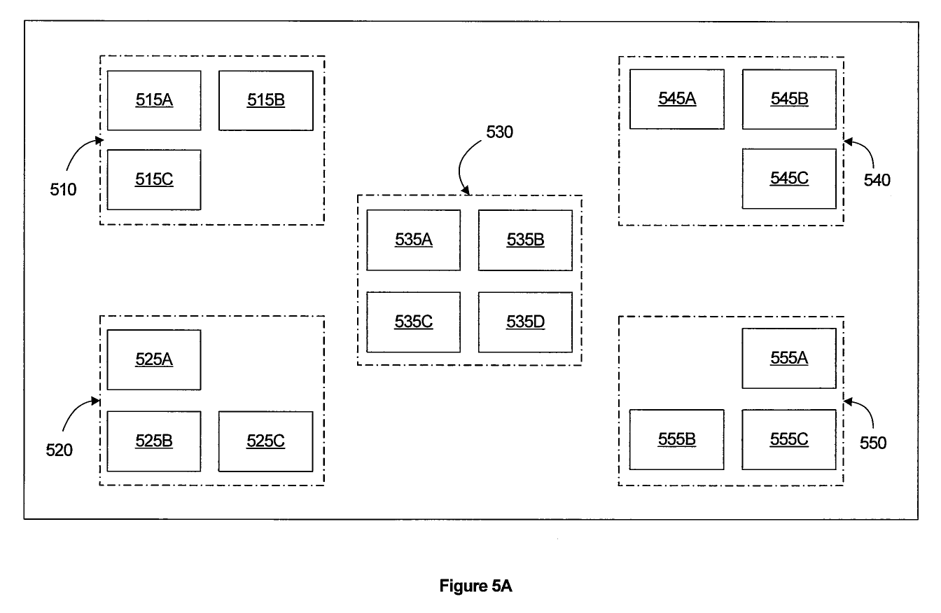

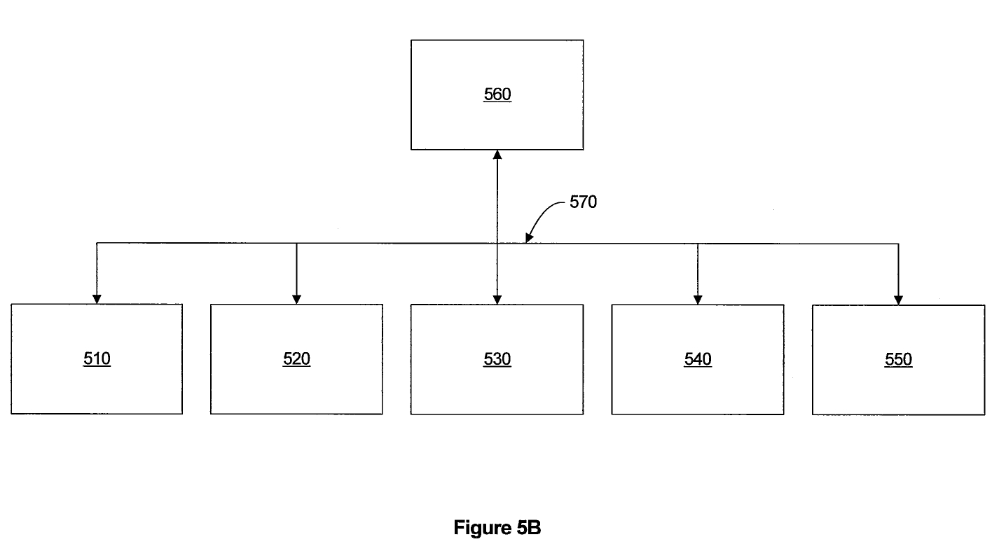

As illustrated in FIG. 5a, electronic gaming machines may be arranged into a series of groups, for example by gaming machines that are within the sensor range of one another or by arbitrary segmentation if a data link is used. FIG. 5A illustrates an arrangement where there are five peer groups of gaming machines in a gaming room 500. A first peer group 510 having gaming machines 515A, 515B and 515C, a second peer group 520 having gaming machines 525A, 525B and 525C, a third peer group 530 having gaming machines 535A, 535B, 535C and 535D, a fourth peer group 540 having gaming machines 545A, 545B, 545C and a fifth peer group 550 having gaming machines 555A, 555B and 555C.

These peer groups 510,520,530,540,550 may be connected in a number of different ways. For example, just as the individual gaming machines within each peer group are connected as peers, the five groups may be created as a super peer group. Alternatively, as illustrated in FIG. 5B, the five groups, 510,520,530,540,550 may be under the control of central controller 560 that sends audio visual modification data by a data link 570 to each of the gaming machines. That is the central controller 560 of FIG. 5B collates audio visual output information from each of the peer groups and determines whether gaming machines of any of the other peer groups should be modified on this basis.

Persons skilled in the art will appreciate that various modifications may be made to the above embodiments. For example referring to FIG. 4, rather than the obtaining data regarding the audio visual output of a peer EGM from a bezel controller, data could be output from one EGM to another that lets the receiving EGM infer the lighting status of a peer EGM such as game outcome data from another EGM.

Further, other elements of interactivity between EGMs become possible to alter the behaviour of EGMs, particularly once a peer-to-peer data link is established, and EGMs (or other electronic gaming components) may include a wide variety of interactive components designed to be controlled in response to interactivity data output from peer EGMs (or based on the sensed audio visual output) to vary the EGMs behaviour. For example, play attributes of an EGM such as rate of spin, payout or bonusing could be affected if, for example, the game outcome generator interacts with the game outcomes of other machines. Similarly, the appearance of symbols, number of wild symbols, frequency of symbols might be varied. Further “excited” EGMs might contribute more to a progressive jackpot or accrue more loyalty points for the players playing them if they have a player tracking card inserted.

In a further variation additional non-peer factors might influence the behaviour of an EGM in addition to peer gaming machines influencing behaviour. For example, data specifying that jackpot building centrally on a jackpot controller has exceeded a predetermined limit might be communicated to each of the EGM in order to change their behaviour.

Persons skilled in the art will appreciate that various other modifications may be made without departing from the scope of the invention described herein. For example, current bezels typically consist of multicoloured LED lighting spaced relatively wide distance apart. These bezels can be modified to incorporate more LEDs. Further, other techniques such as the use of optical fibres could be used to produce a lighting output. As described above, it is not necessary that it be bezel lighting that should be modified for example, the background colour of a game could be varied based on the output of neighbouring gaming machines or an audio output can be altered.

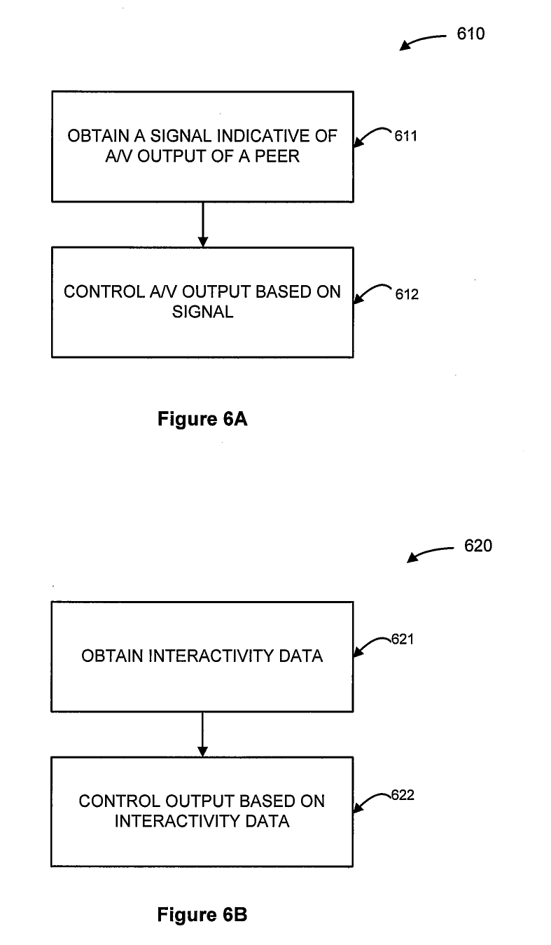

The methods of the above embodiments are summarised in FIGS. 6a and 6b. As will be seen, in one embodiment, the method 610 involves obtaining 611 a signal indicative of an A/V output of a peer electronic gaming component and controlling 612 the output of an A/V device on the basis of the obtained signal. In another embodiment, the method 620 involves obtaining 621 interactive data of a peer electronic gaming component and controlling 622 an interactive component on the basis of the interactivity data.

It will be understood to persons skilled in the art of the invention that many modifications may be made without departing from the spirit and scope of the invention. In particular, it will be appreciated that various features of the above embodiments can be combined to form other embodiments within the scope of the invention.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art in any country.

The claims defining the invention are as follows:

1. An electronic gaming component comprising:
an audio visual (A/V) device comprising an A/V output;
an A/V input arranged to obtain a signal indicative of an A/V output of at least one peer electronic gaming component; and
a controller in communication with the A/V input and arranged to control the A/V output of the A/V device based on the obtained signal.

2. An electronic gaming component as claimed in claim 1, wherein the A/V input comprises a sensor arranged to measure the A/V output of the peer electronic gaming component and to output the signal indicative of the A/V output of the at lease one peer gaming component.

3. An electronic gaming component as claimed in claim 1, wherein the A/V device comprises at least one of an audio output device or a visual output device.

4. An electronic gaming component as claimed in claim 1, wherein, the A/V input is arranged to receive an A/V output communicated from the peer electronic gaming component via a data link.

5. An electronic gaming component as claimed in claim 1, wherein the A/V device comprises a visual output device and the A/V input is arranged to obtain a signal indicative of the visual output of the peer gaming component.

6. An electronic gaming component as claimed in claim 1, wherein the electronic gaming component is an electronic gaming machine (EGM)

7. An electronic gaming component as claimed in claim 6, wherein the A/V device comprises a display of the EGM.

8. An electronic gaming component as claimed in claim 6, wherein the A/V device comprises a light tower of the EGM.

9. An electronic gaming component as claimed in claim 6, wherein the A/V device comprises a lighting bezel of the EGM.

10. An electronic gaming component as claimed in claim 1, wherein the A/V device operates independently of other A/V devices of the electronic gaming component.

11. An electronic gaming component as claimed in claim 6, wherein the controller is further arranged to control the output of the A/V device based on a game outcome of the EGM.

12. An electronic gaming component as claimed in claim 6, wherein the controller is further arranged to control the A/V device based on a current A/V output.

13. An electronic gaming component as claimed in claim 1, the A/V input is arranged to output a signal indicative of an A/V output of at least one peer EGM.

12. An electronic gaming component as claimed in claim 1, wherein the A/V input is arranged to obtain at least one signal indicative of the A/V outputs of a plurality of peer gaming components.

13. An electronic gaming component as claimed in claim 6, configured to control at least one aspect of game play based on the A/V input.

14. A gaming system comprising a plurality of electronic gaming components, each electronic gaming component comprising:
an audio visual (A/V) device comprising an A/V output;
an A/V input arranged to obtain a signal indicative of an A/V output of at least one other electronic gaming component of the plurality of electronic gaming components; and
a controller in communication with the A/V input and arranged to control the A/V output of the A/V device based on the obtained signal.

15. A gaming system as claimed in claim 14, wherein at least one electronic gaming component is an electronic gaming machine.

16. A gaming system as claimed in claim 14 wherein at least one electronic gaming component is a display of a bonus or jackpot system.

17. A gaming system as claimed in claim 14, wherein the plurality of electronic gaming components are connected in a peer-to-peer data network for communicating a signal indicative of an A/V output of at least one other electronic gaming component to the respective A/V inputs.

18. A gaming system as claimed in claim 14, wherein each electronic gaming component is arranged to obtain a signal indicative of the A/V output of each electronic gaming component of a peer group of electronic gaming components to which the EGM belongs.

19. A gaming system as claimed in claim 18, comprising a plurality of peer groups of electronic gaming components, and wherein the A/V input is arranged to obtain a signal indicative of an A/V output of another peer group, and the controller is arranged to control the output of the A/V device.

20. A gaming system as claimed in claim 14, wherein each of the electronic gaming components is an electronic gaming machine.

21. A gaming system as claimed in claim 14, wherein each the A/V input comprises a sensor arranged to measure the A/V output of the at least one electronic gaming component and to output the signal indicative of the A/V output.

22. A gaming system as claimed in claim 14, wherein each A/V device comprises a visual output device and the A/V input is arranged to obtain a signal indicative of the visual output of the at least one other gaming component.

23. A gaming system as claimed in claim 14, wherein the electronic gaming component is an electronic gaming machine (EGM) and the A/V device comprises a display of the EGM.

24. A gaming system as claimed in claim 14, wherein the electronic gaming component is an electronic gaming machine (EGM) and the A/V device comprises a light tower of the EGM.

25. A gaming system as claimed in claim 14, wherein the electronic gaming component is an electronic gaming machine (EGM) and the A/V device comprises a lighting bezel of the EGM.

26. A gaming system as claimed in claim 14, wherein each A/V device operates independently of any other A/V devices of the electronic gaming component.

27. A gaming system as claimed in claim 14, wherein each controller is further arranged to control the output of the A/V device based on a game outcome of the EGM.

28. A gaming system as claimed in claim 14, wherein each controller is further arranged to control the A/V device based on a current A/V output.

29. A gaming system as claimed in claim 14, wherein each electronic gaming component is an electronic gaming machine configured to control at least one aspect of game play based on the A/V input.

30. A controller for an electronic gaming component, the controller arranged to control an A/V output of A/V device of the electronic gaming component based on a signal obtained by an A/V input of the electronic gaming component, the signal being indicative of an A/V output of at least one peer electronic gaming component.

31. A gaming network comprising:
a plurality of peer groups of electronic gaming components, each electronic gaming component comprising an A/V output device, each peer group of electronic gaming components configured such that individual electronic gaming components control their respective A/V output devices based on the A/V output of at least one peer within the group and based on any received A/V modification data; and
a central controller in data communication with each of the groups and arranged to provide A/V modification data to at least one group of the plurality of groups of electronic gaming components based on the output of A/V output devices of at least one other group of electronic gaming components.

32. A gaming network as claimed in claim 31, wherein the electronic gaming components are electronic gaming machines.

33. A method of controlling an audio visual (A/V) device of an electronic gaming component comprising:
obtaining a signal indicative of the A/V output of at least one peer gaming machine; and
controlling the output of the A/V device of the electronic gaming component based on the obtained signal.

34. An electronic gaming component comprising:
at least one interactive component;
an interactivity input arranged to receive interactivity data from at least one peer electronic gaming component; and
a controller arranged to control the interactive component based on the interactivity data.

35. An electronic gaming component as claimed in claim 34 wherein the electronic gaming component is an electronic gaming machine.

36. An electronic gaming component as claimed in 34, wherein the interactive component is selected from the group comprising an audio visual device, a game outcome generator, and a reel controller.

37. An electronic gaming component further comprising an interactivity data output arranged to output interactivity data to at least one other peer EGM.

38. An electronic gaming system comprising a plurality of electronic gaming components connected in a peer-to-peer data network, each electronic gaming component comprising:
at least one interactive component;
an interactivity input arranged to receive interactivity data from at least one peer electronic gaming component; and
a controller arranged to control the interactive component based on the interactivity data.

39. An electronic gaming system as claimed in claim 38, wherein the interactivity input is arranged to receive interactivity data from all peers in the peer-to-peer network.

40. A controller for an electronic gaming component, the controller arranged to control an interactive component of the electronic gaming component based on interactivity data received from at least one peer electronic gaming component.

41. A gaming network comprising:
a plurality of peer groups of electronic gaming components, each electronic gaming component comprising at least one interactive component, each peer group of electronic gaming components configured such that individual electronic gaming components control their interactive components based on interactivity data received from at least one peer within the group and based on any received interactivity modification data; and
a central controller in data communication with each of the groups and arranged to provide interactivity modification data to at least one group of the plurality of groups of electronic gaming components based on the interactivity data of at least one other group of electronic gaming components.

42. A method of controlling an interactive component of an electronic gaming electronic gaming component comprising:
receiving interactivity data from at least one peer gaming machine; and
controlling the interactive component of the electronic gaming component based on the received signal.
